(19) United States
(12) Patent Application Publication
(10) Pub. No.: US 2017/0214056 A1
(43) Pub. Date: Jul. 27, 2017

(54) METHOD FOR MANUFACTURING CURRENT COLLECTOR LAYER

(71) Applicant: ASUSTeK COMPUTER INC., Taipei City (TW)

(72) Inventor: Fei-Lin Yang, Taipei City (TW)

(73) Assignee: ASUSTeK COMPUTER INC., Taipei City (TW)

(21) Appl. No.: 15/407,212

(22) Filed: Jan. 16, 2017

(30) Foreign Application Priority Data
Jan. 27, 2016 (TW) 105102583

(51) Int. Cl. H01M 4/66; H01M 10/34; C25D 3/12; H01M 10/0525; C25D 3/44; C25D 3/38

(52) U.S. Cl. CPC H01M 4/661; C25D 3/44; C25D 3/38; C25D 3/12; H01M 10/0525; H01M 10/345

(57) ABSTRACT

A method for manufacturing a current collector layer is provided. The method comprises: forking a release layer on a surface of a film; forming an adhesive layer on the release layer; forming a metal layer on the adhesive layer; and removing the film and the release layer.

### CROSS-REFERENCE TO RELATED APPLICATION

This application claims the priority benefit of TW application serial no. 105102583,filed on Jan. 27, 2016. The entirety of the above-mentioned patent application is hereby incorporated by reference herein and made a part of this specification.

### BACKGROUND OF THE INVENTION

Field of the Invention

The disclosure relates to a method for manufacturing a current collector layer and, more specifically, to a method for manufacturing a thin current collector layer.

Description of the Related Art

Generally, the operation mechanism of a battery is relied on redox reactions that generated between positive, negative electrodes and electrolytes, the formed circulatory system generates a current and functions as a battery. When the battery discharges, ions moves from the negative electrode to the positive electrode through the electrolytes. At the same time, electrons move to the positive electrode from an external circuit to generate current. The positive and negative electrodes are coated on a current collector layer. The current collector layer is served as a conductor for the electrons during the charging and discharging processes of the battery.

### BRIEF SUMMARY OF THE INVENTION

According to an aspect of the disclosure, a method for manufacturing a current collector layer is provided. The method comprises: forming a release layer on a surface of a film; forming an adhesive layer on the release layer; forming a metal layer on the adhesive layer; and removing the film and the release layer.

### BRIEF DESCRIPTION OF THE DRAWINGS

These and other features, aspects and advantages of the disclosure will become better understood with regard to the following embodiments and accompanying drawings.

FIG. 1 is a flow chart of a method for manufacturing a current collector layer in an embodiment;

FIG. 2A to FIG. 2D are section views showing the process in manufacturing a current collector layer according to the flow chart in FIG. 1 in an embodiment; and

FIG. 3 is a flow chart of a method for manufacturing a current collector layer in an embodiment.

### DETAILED DESCRIPTION OF THE EMBODIMENTS

The invention is described accompanying with the figures. The invention may be implemented in different forms, and embodiments described hereinafter are not used for limiting the invention. For clarity, thickness of layers/areas shown in the figures is enlarged.

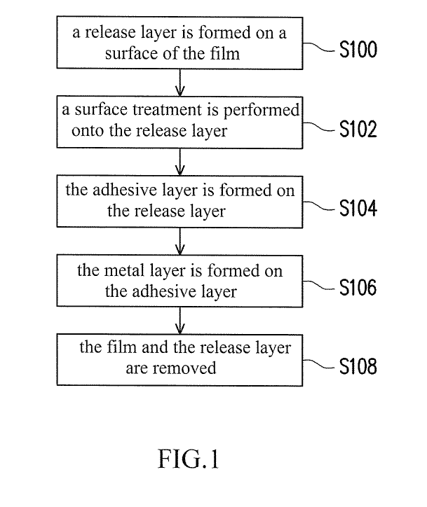

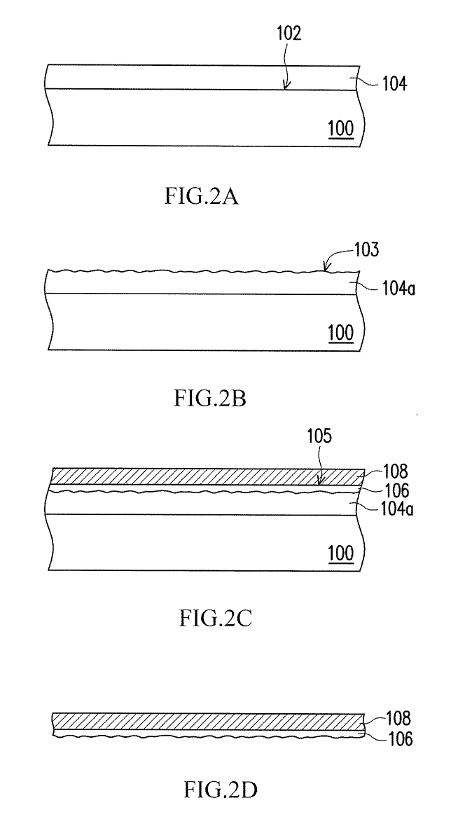

FIG. 1 is a flow chart of a method for manufacturing a current collector layer in an embodiment. FIG. 2A to FIG. 2D are section views showing the process in manufacturing a current collector layer according to the flow chart in FIG. 1 in an embodiment.

Please refer to FIG. 1 and FIG. 2A, a method for manufacturing a current collector layer includes following steps. A film 100 is provided. In an embodiment, the material of the film 100 is one or a combination selected from the group consisting: polyethylene terephthalate (PET), polycarbonate (PC) and polymethyl methacrylate (PMMA), which is not limited herein. In an embodiment, the film 100 is made of other resin materials. In an embodiment, the thickness of the film 100 is between 50 μm˜300 μm.

Then, in step S100, a release layer 104 is formed on a surface 102 of the film 100. In an embodiment, the release layer 104 is formed by coating a release agent on the surface 102 of the film 100 and then drying the release agent. In an embodiment, the drying treatment is performed at a temperature of 25° C.˜70° C. As shown in FIG. 2A, in an embodiment, the surface 102 is an upper surface of the film 100, which is not limited herein. In another embodiment, the surface 102 is a lower surface of the film 100.

The release agent is one or a combination selected from the group consisting a fluorine-containing organic compound, a chlorine-containing polymer and a silicon-containing organic compound, which is not limited herein. In an embodiment, the fluorine-containing organic compound is one or a combination selected from the group consisting polytetrafluoroethene (PTEF), polyvinylidene difluoride (PVDF) and fluorinated ethylene propylene copolymer (FEP). In an embodiment, the chlorine-containing polymer is polyvinyl chloride (PVC). In an embodiment, the silicon-containing organic compound includes polyester and/or silicone resin. However, the material of the release agent is not limited herein. In an embodiment, any material with low surface energy that does not react easily with adjacent materials can be used as the release agent.

Please refer to FIG. 1, FIG. 2A and FIG. 2B, then, step S102 is selectively performed. A surface treatment is performed onto the surface 103 of the release layer 104 to make the surface of the release layer 104a roughened. In an embodiment, the surface treatment is one or a combination selected from the group consisting a plasma treatment, an ion source treatment and a spark treatment. In an embodiment, any surface treatment for roughening the surface of the release layer 104a can be used.

In the embodiment, the surface energy of the surface 103 of the release layer 104a is increased and the surface 103 is roughened and uneven via the surface treatment onto the release layer 104 in step S102. Therefore, an adhesion force between the release layer 104a and an adhesive layer 106 (which is subsequently formed as shown in FIG. 2C) is increased via roughened surface 103 to avoid the detachment of the adhesive layer 106.

Please refer to FIG. 1, FIG. 2B and FIG. 2C, then, in step S104, the adhesive layer 106 is formed on the release layer 104a. In an embodiment, the adhesive layer 106 increases the adhesion force between the release layer 104a and the metal layer 108 (which is subsequently formed) to avoid the detachment of the metal layer 108. In an embodiment, the material of the adhesive layer 106 includes silicon oxide and/or titanium oxide. In an embodiment, the thickness of the adhesive layer 106 is less than 0.1 μm and the adhesive layer 106 is formed via a dry deposition method. The dry deposition method includes a physical vapor deposition method and/or an atomic layer deposition. The physical vapor deposition method is sputtering, evaporation or e-Gun evaporation, which is not limited herein. In an embodiment, any dry deposition method at a processing temperature below 150° C. can be used.

In the embodiment, the adhesive layer 106 is formed via the dry deposition method. The adhesion force between the adhesive layer 106 and the release layer 104a is increased via the roughened surface 103. Thus, the thickness of the adhesive layer 106 is less than 0.1 μm to avoid a lower conductivity of the finished current collector layer.

Then, please refer to FIG. 1 and FIG. 2C, in step S106, the metal layer 108 is formed on the adhesive layer 106. The material of the metal layer 108 includes one or a combination selected from the group consisting copper, aluminum, nickel and tin. In an embodiment, the metal layer 108 is formed via a dry deposition method. The dry deposition method includes a physical vapor deposition (PVD) and/or an atomic layer deposition (ALD) The physical vapor deposition (PVD) includes sputtering, evaporation or e-Gun evaporation. In an embodiment, any dry deposition method at a processing temperature below 150° C. can be used.

In an embodiment, the metal layer 108 is formed via a wet deposition method. The wet deposition method includes electroplating and/or chemical plating. When the metal layer 108 is formed by the wet deposition method, an activated layer is formed on the surface 105 of the adhesive layer 106 before the metal layer 108 is formed. The activated layer includes at least one metallic element used as a metal catalyst to accelerate the deposition of the metal layer 108. In an embodiment, the activated layer is formed by using electrolytes including one or a combination selected from the group consisting palladium chloride, ruthenium chloride and thallium chloride to activate and sensitize the surface 105 of the adhesive layer 106, and then the palladium (Pd), the ruthenium (Ru) or the thallium (Tl) is attached to the surface of the adhesive layer 106 to improve the conductivity and activity of the adhesive layer 106.

Problems of calendering effects of materials and limitations from the thickness of a rolling device are solved via the dry deposition method or the wet deposition method. Therefore, the thickness of the metal layer 108 is made less than 3 μm. In an embodiment, the thickness of the metal layer 108 is between 0.5 μm to 2.5 μm.

Please refer to FIG. 1, FIG. 2C and FIG. 2D, in step S108, the film 100 and the release layer 104a are removed. After the film 100 and the release layer 104a are removed, the adhesive layer 106 and the metal layer 108 are left. The thinner the adhesive layer 106 (for example, less than 0.1 μm), the better the conductivity of the metal layer 108.

In the embodiment, the metal layer 108 is used as current collector layers of positive and negative electrodes in a battery unit. The positive and negative electrodes are stacked alternatively to form the battery. Therefore, in the embodiment, when the single metal layer 108 (as the current collector layer of either the positive electrode or the negative electrode) becomes thinner, the whole thickness of the stacked battery is reduced, and thus the available space of the battery is increased. In such a way, the efficiency of the battery is improved.

In an embodiment, the material of the metal layer 108 is various for different types of the battery. In an embodiment, in a lithium ion battery, the current collector layer of the positive electrode is aluminum, and the current collector layer of the negative electrode is copper. The battery can be any type only if a potential difference (PD) exits between plate materials of the positive electrode and the plate materials of the negative electrode. In an embodiment, in a nickel-hydrogen battery, nickel is used as the material of the current collector layer of the positive electrode.

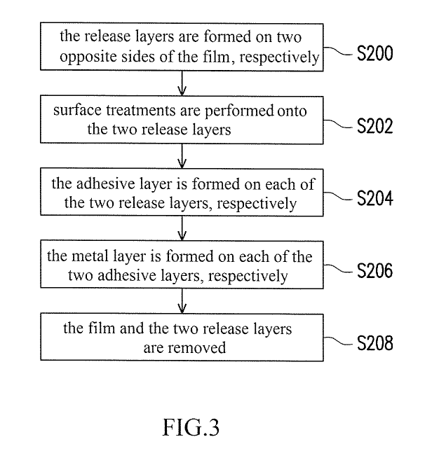

FIG. 3 is a flow chart of a method for manufacturing a current collector layer in an embodiment.

Please refer to FIG. 1 and FIG. 3, in an embodiment, a method for manufacturing a current collector layer includes following steps. In step S200, the release layers are formed on two opposite sides of the film, respectively. Then, step S202 is selectively performed, in which surface treatments are performed onto the two release layers. Then, in step S204 and step S206, the adhesive layer is formed on each of the two release layers, respectively. Then, the metal layer is formed on each of the two adhesive layers, respectively. At last, in step S208, the film and the two release layers are removed to form two composite layers including the metal layer and the adhesive layer. Since the materials, the thickness and the forming methods of the film, the release layer, the adhesive layer and the metal layer are described above, which are not described herein.

In sum, in embodiments, the metal layer is formed on the release layer via the dry deposition method or the wet deposition method, and thus the thickness of the metal layer is made less than 3 μm. Therefore, when the metal layer is used as the current collector layer of the battery, the whole thickness of the battery is reduced and the efficiency of the battery is improved. Furthermore, before the metal layer is formed, the adhesive layer is formed on the release layer to increase the metal adhesion force to avoid the detachment of the metal layer.

Additionally, in an embodiment, the metal layers are formed on the opposite sides of the film, respectively. After the film and two release layers are removed, two separate composite layers each consisting of the metal layer and the adhesive layer are obtained. Therefore, the method for forming the metal layer reduces the cost.

Although the disclosure has been disclosed with reference to certain embodiments thereof, the disclosure is not for limiting the scope. Persons having ordinary skill in the art may make various modifications and changes without departing from the scope of the disclosure. Therefore, the scope of the appended claims should not be limited to the description of the embodiments described above.

What is claimed is:

1. A method for manufacturing a current collector layer, comprising:
forming a release layer on a surface of a film;
forming an adhesive layer on the release layer;
forming a metal layer on the adhesive layer; and
removing the film and the release layer.

2. The method for manufacturing the current collector layer according to claim 1, wherein the step of forming the release layer on the surface of the film includes:
coating a release agent on the surface of the film; and
performing a drying treatment to the release agent.

3. The method for manufacturing the current collector layer according to claim 2, wherein the release agent includes one or a combination selected from the group consisting a fluorine-containing organic compound, a chlorine-containing polymer and a silicon-containing organic compound.

4. The method for manufacturing the current collector layer according to claim 3, wherein the fluorine-containing organic compound include one or a combination selected from the group consisting polytetrafluoroethene (PTEF), polyvinylidene difluoride (PVDF) and fluorinated ethylene propylene copolymer (FEP).

5. The method for manufacturing the current collector layer according to claim 3, wherein the chlorine-containing polymer includes polyvinyl chloride (PVC), and the silicon-containing organic compound includes polyester and/or silicone resin.

6. The method for manufacturing the current collector layer according to claim 1, wherein a surface treatment is performed onto the release layer before the adhesive layer is formed on the release layer.

7. The method for manufacturing the current collector layer according to claim 6, wherein the surface treatment includes one or a combination selected from the group consisting a plasma treatment, an ion source treatment and a spark treatment.

8. The method for manufacturing the current collector layer according to claim 1, wherein the material of the adhesive layer includes silicon oxide and/or titanium oxide.

9. The method for manufacturing the current collector layer according to claim 1, wherein a method for forming the metal layer includes a wet deposition method, and the wet deposition method includes electroplating and/or chemical plating.

10. The method for manufacturing the current collector layer according to claim 1, wherein the material of the film includes one or a combination selected from the group consisting polyethylene terephthalate (PET), polycarbonate (PC) and polymethyl methacrylate (PMMA).
